(19) United States
(12) Patent Application Publication
(10) Pub. No.: US 2022/0182529 A1
(43) Pub. Date: Jun. 9, 2022

(54) REMOTELY TRIGGERED INFRARED SPOTLIGHT SYSTEM AND METHOD OF USE

(71) Applicant: WilliamsRDM, Inc., Fort Worth, TX (US)

(72) Inventors: Christopher M. Stimek, Fort Worth, TX (US); Eduardo M. Hinojosa, Fort Worth, TX (US)

(73) Assignee: WilliamsRDM, Inc., Fort Worth, TX (US)

(21) Appl. No.: 17/543,625

(22) Filed: Dec. 6, 2021

Related U.S. Application Data
(60) Provisional application No. 63/122,885, filed on Dec. 8, 2020.

(51) Int. Cl. H04N 5/235; H04N 5/225

(52) U.S. Cl. CPC H04N 5/2354; H04N 5/2256

(57) ABSTRACT

A spotlight system is provided that includes a camera assembly having an infrared camera and an infrared flash. The system includes a spotlight assembly having an infrared spotlight and an infrared sensor. The spotlight assembly is located remotely from the camera assembly, the infrared sensor is communicatively coupled to the infrared spotlight and the infrared sensor and is configured to detect the infrared flash. The infrared spotlight is configured to illuminate in response to the infrared sensor detecting the infrared flash

### CROSS-REFERENCE TO RELATED PATENT APPLICATIONS

The disclosure claims priority to and benefit of U.S. Provisional Appl. No. 63/122,885, filed Dec. 8, 2020, the entire disclosure of which is hereby incorporated by reference herein

### BACKGROUND

Trail cameras are used to automatically take photographs, videos and/or enable viewing of objects that move across a field of view. For nighttime use, the cameras have an infrared flash that can illuminate the objects for an infrared sensitive camera. However, the infrared flash becomes less useful at longer distances, and depending on the distance, can be rendered useless. This can result in user frustration who desires to utilize the flash at longer distances at night.

### SUMMARY OF THE INVENTION

This disclosure describes methods and systems for a spotlight system. A spotlight provides an increased range of view for the infrared camera. For example, the spotlight may be positioned remotely from the camera and configured to respond to the camera flash, thus illuminating a greater range of space for the camera to more clearly photograph the object. As explained in the present disclosure, the spotlight system reduces the risk and hassle of not capturing a quality video, photo or other recording of the desired object at greater distances, particularly at night.

According to a first aspect, there is provided a spotlight system that includes a camera assembly having an infrared camera and an infrared flash. The system includes a spotlight assembly having an infrared spotlight and an infrared sensor. The spotlight assembly is located remotely from the camera assembly, the infrared sensor is communicatively coupled to the infrared spotlight and the infrared sensor and is configured to detect the infrared flash. The infrared spotlight is configured to illuminate in response to the infrared sensor detecting the infrared flash.

According to some embodiments, the spotlight system includes a second sensor coupled to the infrared spotlight. The second sensor is configured to detect a visible light.

In other embodiments, the camera assembly includes a first power source coupled to the infrared camera and the spotlight assembly includes a second power source coupled to the infrared spotlight.

In yet another embodiment, the infrared spotlight is configured to remain illuminated for a user defined duration, after the infrared spotlight has been triggered.

In another embodiment, the infrared spotlight is configured to illuminate only after a predetermined amount of time has passed or been exceeded since a previous illumination.

According to yet other embodiments, the spotlight system further includes a plurality of infrared spotlights each coupled to the infrared sensor of the spotlight assembly.

In yet another embodiment, the spotlight system includes a sensor coupled to the infrared camera and the infrared flash, the infrared flash configured to illuminate in response to the sensor receiving a signal.

In other embodiments, the sensor coupled to the infrared camera is at least one of an infrared sensor, a seismic sensor, a passive infrared sensor, a magnetometer, or a radar.

In still other embodiments, the signal is generated from at least one of an animal, a human, a vehicle, or other object.

According to a second aspect, there is provided an infrared spotlight system. The system includes an infrared camera coupled to an infrared flash and a sensor capable of detecting a stimuli and generating a signal. The sensor is communicatively coupled to the infrared camera. The infrared flash is configured to illuminate upon receiving the signal generated by the sensor and an infrared spotlight located remotely from the infrared camera. The system further includes an infrared sensor coupled to the infrared spotlight, the infrared sensor configured to detect the infrared flash. Additionally, the infrared spotlight is configured to illuminate when the infrared sensor detects the infrared flash from the infrared camera.

According to some embodiments, the infrared spotlight system includes a second infrared spotlight sensor coupled to the infrared spotlight. The second infrared spotlight sensor is configured to detect visible light.

In yet another embodiment, the infrared spotlight system includes a power source coupled to the infrared spotlight.

In still other embodiments, the infrared spotlight system includes a plurality of infrared spotlights each coupled to the infrared sensor.

In yet another embodiment, the infrared spotlight extends lighting beyond an area where the infrared flash of the infrared camera is capable of illuminating.

According to a third aspect, there is provided a method of using a spotlight system. The method includes detecting an object by a sensor, illuminating an infrared flash of an infrared camera in response to detecting the object. The method further includes detecting the infrared flash via an infrared sensor and illuminating an infrared spotlight in response to detecting the infrared flash. The infrared sensor and the infrared spotlight are located remotely from the infrared camera.

In some embodiments, the method includes detecting an amount of visible light via a second sensor coupled to the infrared spotlight.

In yet other embodiments, the infrared spotlight is configured to transition to a reduced power mode in response to the detecting of the amount visible light by the second sensor.

In other embodiments, the method further includes powering the infrared camera via a first power source coupled to the infrared camera and powering the infrared spotlight via a second power source coupled to the infrared spotlight.

In still other embodiments, wherein the infrared spotlight illuminates for a user defined duration.

In yet another embodiment, the method includes determining whether a predetermined amount of time has passed since a previous illumination, the infrared spotlight illuminating if the predetermined amount of time has passed or been exceeded.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A is an illustration of an embodiment of a spotlight system that is employed to illuminate an extended usable viewing area.

FIG. 1B is an illustration of another embodiment of a spotlight system that is employed to illuminate an extended viewing area.

FIG. 2 is an illustration of the spotlight system of FIGS. 1A and 1B, incorporating a camera assembly and a spotlight assembly.

FIG. 3 is a flow chart illustrating a method of using the spotlight system of FIGS. 1A, 1B and 2.

The drawings are not necessarily to scale and certain features may be shown exaggerated in scale or in somewhat schematic form in the interest of clarity and conciseness.

### DETAILED DESCRIPTION

Embodiments disclosed herein provide a system, an apparatus, and a method for an independently triggered external infrared spotlight system 10. In particular, embodiments disclosed herein provide a spotlight assembly 22 or other illumination device or light source that can be remotely positioned from a camera 14, including for example, an infrared camera, to extend the camera's 14 illumination area and thus ability to view and record images at extended distances during darkness.

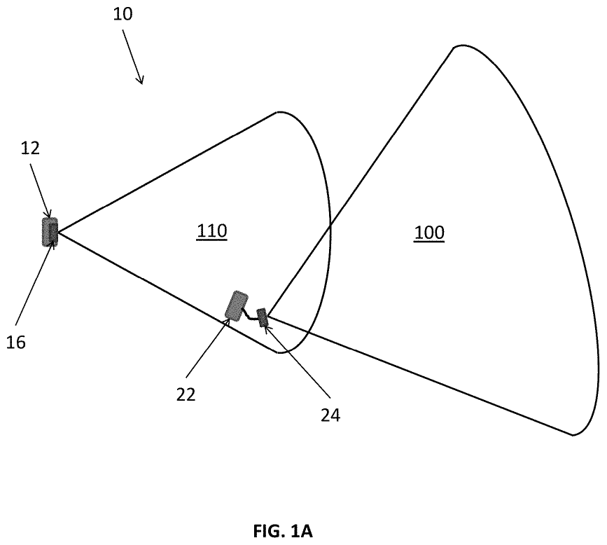

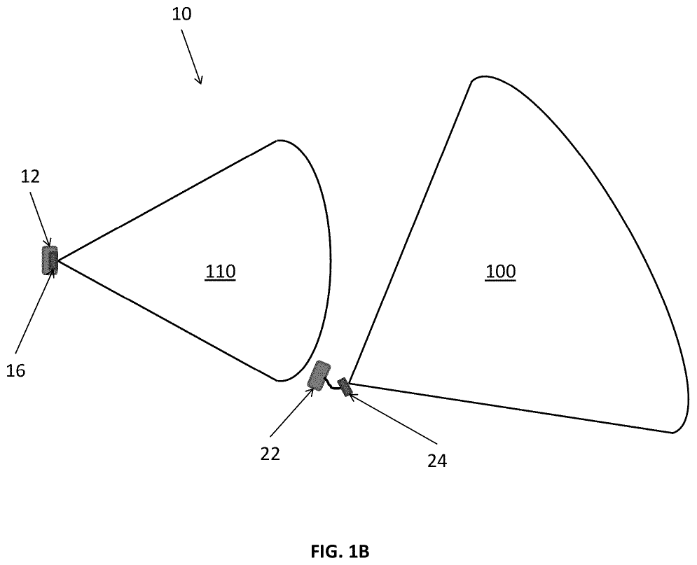

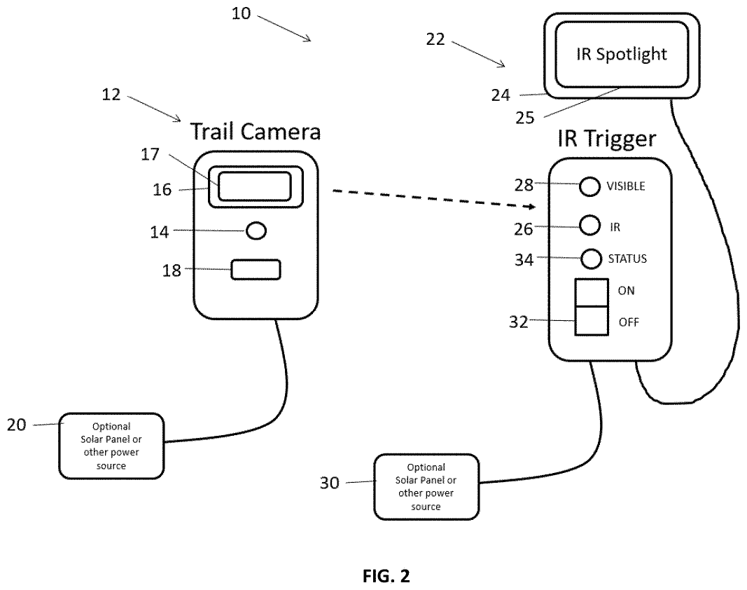

Referring specifically to FIG. 1A, a spotlight system 10 includes a camera assembly 12 that employs and otherwise communicates with the spotlight assembly 22 to illuminate an extended usable viewing area 100. As used herein, the term extended usable viewing area 100 is the area beyond or otherwise outside of a camera flash area 110 generated by a flash 16 on or used by camera assembly 12. In use, the extended usable viewing area 100 is illuminated by an illumination device, a flash member, or a spotlight 24. Accordingly, the usable range of the camera assembly 12 is effectively increased during periods of low light or the nighttime hours so as to capture images within the extended usable viewing area 100. In response to triggering the camera assembly 12 and illuminating the flash 16 thereon, a sensor 26 (FIG. 2) connected to the spotlight assembly 22 positioned within the camera flash area 110 detects the light generated/produced from the flash 16. Upon detection, the remotely positioned spotlight 24 of the spotlight assembly 22 illuminates the extended usable viewing area 100 to enable the camera assembly 12 to capture an image at an extended distance.

FIG. 1B illustrates another embodiment of a spotlight system 10 in which a camera assembly 12 employs and otherwise communicates with a spotlight assembly 22 disposed outside of the camera flash area 110 to, similar to the above discussion, illuminate an extended usable viewing area 100. In use, the extended usable viewing area 100 is illuminated by a spotlight, flash member, or other illumination device 24. In response to triggering the camera assembly 12 and illuminating the flash 16 thereon, a sensor 26 (FIG. 2) on the spotlight assembly 22 positioned beyond or otherwise outside the camera flash area 110 detects the light generated/produced from the flash 16. Upon detection, the remotely positioned spotlight 24 of the spotlight assembly 22 illuminates the extended usable viewing area 100 to enable the camera assembly 12 to capture an image at extended distance.

As illustrated in the embodiments illustrated in FIGS. 1A and 1B, the spotlight assembly 22 may be positioned within the camera flash area 110 (FIG. 1A), or beyond or otherwise outside of the camera flash area 110 (FIG. 1B), in cases where the sensitivity of a sensor 26 on the spotlight assembly 22 can detect a flash 16 outside of the camera flash area 110 even though the flash 16 may not be able to adequately illuminate an animal, object, or human in the extended viewing area such that the camera 14 may capture a desirable photograph or other desirable recording thereof. In other words, the infrared flash 16 provided with the infrared camera 14 may not be sized to illuminate objects at greater distances. However, the infrared sensor 26 can be highly sensitive and as such, can oftentimes detect the light from the infrared flash 16 even if the infrared flash 16 is not bright enough to illuminate the object. By providing the spotlight assembly 22, an area (i.e., the extended usable viewing area 100) outside of the area that is illuminated by the infrared flash 16 (i.e., the camera flash area 110) can be illuminated, thus further enhancing the object for a clearer viewing, recording and/or photographing by the infrared camera 14.

In the embodiments illustrated in FIGS. 1A, 1B, and 2, the spotlight system 10 comprises the camera assembly 12 spaced apart from the spotlight assembly 22 by a predetermined distance. Referring specifically to FIG. 2, the camera assembly 12 is sized and otherwise configured to house, enclose and/or otherwise support a camera 14, such as, for example, an infrared camera 14, an illumination device, spotlight, or flash 16, such as, for example, an infrared flash, and a sensor 18. In some embodiments, the camera assembly 12 may be a readily and/or commercially available trail camera. In another embodiment, the infrared flash 16 and the sensor 18 may be separate components that are contained in different enclosure(s) from the camera 14. For example, the sensor 18 may be placed in a tree and the spotlight assembly 22 may be mounted in a separate location to illuminate the viewing area. In such a configuration, the sensor 18 and the infrared camera 14 may be communicatively coupled via a cable or a wireless configuration. The spotlight assembly 22 can be coupled to the camera 14 such that the camera 14 and the spotlight assembly 22 are configured to operate simultaneously to illuminate the extended usable viewing area 100, as illustrated in FIGS. 1A and 1B, in order to increase the visibility of an animal, object, or human being recorded and/or photographed by the camera 14. Further, in other embodiments, the infrared flash 16 may be connected via a cable to the spotlight assembly 22.

As illustrated in the embodiment of FIG. 2, the camera assembly 12 optionally includes a power source 20, for providing power to operate the camera assembly 12 (e.g., the camera 14, the infrared flash 16, the sensor 18 and any other component thereof such as, for example a clock, external light source, speaker, etc.). The power source 20 may include, by way of example, batteries or a connection to an external source of power such as building power, an external battery, a solar panel, or any other suitable power generating or power storing device. The power source 20 may be an external component of the camera assembly 12 that is capable of being positioned remotely from the camera assembly 12 or integrated within the camera assembly 12. In some embodiments, the power source 20 can include a component positioned remotely from the camera assembly 12 and a component integrated in the same location as the camera assembly 12 such as a backup battery or other source of power. For example, the power source 20 can be connected to the camera assembly 12 via a cable. The sensor 18 may further be configured to filter out visible light (e.g., from a headlight, spotlight, or other sources of visible light) or light with high visible content to prevent such light from triggering the camera 14.

In some embodiments, the sensor 18 is configured to communicate with the infrared camera 14 when a signal is received indicating the presence of an animal, object, or human thus triggering the infrared camera 14 and the infrared flash 16 simultaneously in order to capture, record and/or photograph the animal, object, human, or any other moving object.

According to embodiments disclosed herein, the camera 14 may be an off-the-shelf camera with infrared capabilities such as an off-the-shelf trail camera and the sensor 18 may be, by way of example, an infrared sensor, a seismic sensor, a passive infrared sensor, a magnetometer sensor, or a radar.

According to some embodiments, the infrared flash 16 passes through a lens 17 to condition the infrared flash 16 in such a way as to diffuse, diffract, refract, or otherwise direct the infrared flash 16 over a wider area or over a more concentrated area than would be capable without the lens 17. Similarly, according to another embodiment, the spotlight 24 can also be configured to operate with a lens 25 that can condition the spotlight 24 in such a way as to diffuse, diffract, refract, or otherwise direct the spotlight 24 over a wider area or over a more concentrated area than would be capable without the lens 25. According to another embodiment, both the camera assembly 12 and the spotlight assembly 22 can also be configured to operate without their respective lenses 17, 25.

In the embodiment illustrated in FIG. 2, the spotlight assembly 22 is configured, sized and otherwise formed to include a spotlight 24 or other light source, such as an infrared spotlight 24, and a sensor 26, such as an infrared sensor 26. In operation and as previously explained, the infrared sensor 26 is positioned to detect the infrared light emitted by the infrared flash 16. In response to detection of the infrared flash 16, a signal is sent to the spotlight 24 to illuminate to enable viewing of the extended usable viewing area 100 such that the camera assembly 12 can capture images within the extended usable viewing area 100. In another embodiment, the infrared spotlight 24 and the infrared sensor 26 may be separate components that are contained in different enclosure(s). For example, the infrared sensor 26 may be placed in a tree and the spotlight 24 may be mounted in a separate location to illuminate the viewing area. In such a configuration, the sensor 26 and the infrared spotlight 24 may be communicatively coupled via a cable or other wireless configuration. In some embodiments, the components of the spotlight assembly 22 can all be positioned remotely from one another.

In the embodiment illustrated in FIG. 2, the spotlight assembly 22 includes a power source 30 for operating and/or using the spotlight assembly 22 (e.g., the spotlight 24 and sensor 26 and/or any other component thereof such as for example a clock, a light emitting diode (hereinafter referred to as “LED”), an external light source, a speaker, etc.). The power source 30 may include, by way of example, batteries or a connection to an external source of power such as building power, an external battery, an external solar panel, etc., such that the power source 30 can be positioned remotely from the spotlight assembly 22. In some embodiments, the power source 30 can include a component positioned remotely from the spotlight assembly 22 and a component positioned in the same location or the same enclosure(s) as the spotlight assembly 22 such as, for example a backup battery, a solar panel, or another source of power.

According to some embodiments, the spotlight assembly 22 can be configured to operate with a plurality of sensors, including for example, a sensor 28 to detect brightness levels such as daylight or any other condition that would make operation or use of the spotlight 24 unnecessary. Thus, the infrared spotlight 24 can be configured to illuminate upon being triggered from the sensor 26 only in response to the absence of daylight detected by the sensor 28, thereby reducing power usage by the spotlight assembly 22. Additionally, the sensor 28 can be used to sense daylight or any other form of visible light such that in daytime conditions, the spotlight assembly 22 can be configured to transition to a low or reduced power mode during the day to save power. In some embodiments, the sensor 28 can be configured to be positioned remotely from the spotlight assembly 22. The infrared sensor 26 and the sensor 28 may be positioned such that they are in the same enclosure, remote from one another in separate enclosures. The infrared sensor 26 and the sensor 28 can also both be in separate and remote locations from the remaining components of the spotlight assembly 22 in some embodiments. In addition, the spotlight assembly 22 may be otherwise configured. For example, the power source 30, IR spotlight 24 and the sensors 26 and 28 may be all positioned within the same enclosure. According to some embodiments, the enclosure for the spotlight assembly 22 can be a molded assembly that is sized to receive and support all or a portion of the above-mentioned components. According to some embodiments, the enclosure can be painted to provide a more covert enclosure and can be coated to cause the light from the IR spotlight 24 to diffuse to a wider area.

In various embodiments, the infrared spotlight 24 can be configured to remain illuminated for a user defined duration once it has been triggered. For example, once triggered, the infrared spotlight 24 can continue to illuminate the object for several seconds, several minutes, or as long as the user desires depending on the use. Similarly, the infrared spotlight 24 can be configured to illuminate only after a predetermined amount of time has passed or been exceeded since the previous illumination. In other words, once triggered, the infrared spotlight 24 can be prevented from illuminating if the infrared spotlight 24 had been triggered recently. For example, if the user knows that the same animal, object, or human may be entering the triggering area covered by the sensor 18, multiple times in a certain period of time, the user can configure the infrared spotlight 24 to pause after an illumination in order to avoid capturing multiple images of the same object.

Further, in various embodiments, a plurality of spotlight assemblies 22 can be used with a plurality of camera assemblies 12. For instance, a plurality of infrared spotlights 24 can be communicatively coupled to an infrared sensor 26 and configured to detect the same infrared flash 16. In other embodiments, one or more infrared cameras 14 may be communicatively coupled with one or more sensors 18. A plurality of infrared sensors 26 may each be coupled to the infrared spotlight 24 of the spotlight assembly 22. The plurality of infrared sensors 26 may be oriented in different directions for better coverage. In some embodiments in which multiple flashes are used, the pause can help to prevent multiple flashes from triggering each other.

In various embodiments, the spotlight assembly 22 can include a power switch or button 32 and a user interface 34, such as for example, an LED, a speaker, and/or display screen such as a liquid crystal display (hereinafter referred to as “LCD”). The user interface 34 can be configured to indicate various conditions such as, for example, whether the unit is powered, remaining battery life, a status, one or more fault conditions, and/or proper or improper alignment of the spotlight assembly 22 with a sensor. For example, the fault conditions can be used to communicate a fault to a user by emitting different colors, or color patterns, blinking, displaying instructions via an LCD screen, announcing the fault or condition via the speaker, or any other means in order to communicate a fault condition or a status to a user.

According to another embodiment, the spotlight assembly 22 can be configured to operate in response to various other stimuli that do not require a camera 14. For example, the infrared sensor 26 may respond to a metal detector that flashes an infrared flash when it is triggered, thus causing the infrared spotlight 24 to illuminate a space or object.

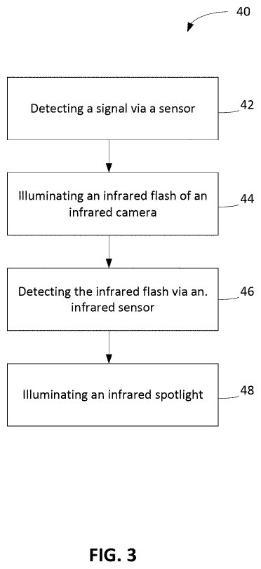

With specific reference to the spotlight system 10 illustrated in FIGS. 1A, 1B, and the block diagram provided in FIG. 3, a method 40 of using the spotlight system 10 is provided. At step 42, a sensor 18 detects a signal generated as a result of the detection of an animal, an object, a human, a vehicle, or any other article desired to be viewed, photographed or otherwise recorded. At step 44, in response to detecting the signal, an infrared flash 16 of an infrared camera 14 is illuminated. At step 46, an infrared sensor 26 communicatively coupled with the spotlight assembly 22 detects the infrared flash 16. At step 48, in response to detecting the infrared flash 16, the infrared spotlight 24 is illuminated. The infrared spotlight 24 continues to illuminate the object and/or the extended usable viewing area 100 for several seconds, several minutes, or as long as the user desires.

It should be understood that the spotlight system 10 can be sold together as a complete system; however, that is not required. For example, a user can utilize its own camera to be used with the spotlight assembly 22.

Although embodiments of the spotlight system 10 have been described in detail, those skilled in the art will also recognize that various substitutions and modifications may be made without departing from the scope and spirit of the appended claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A spotlight system comprising:
a camera assembly having an infrared camera and an infrared flash;
a spotlight assembly having an infrared spotlight and an infrared sensor wherein the spotlight assembly is located remotely from the camera assembly;
the infrared sensor is communicatively coupled to the infrared spotlight and the infrared sensor configured to detect the infrared flash; and
the infrared spotlight is configured to illuminate in response to the infrared sensor detecting the infrared flash.

2. The spotlight system of claim 1, further comprising a second sensor coupled to the infrared spotlight wherein the second sensor is configured to detect a visible light.

3. The spotlight system of claim 1, wherein the camera assembly further comprises a first power source coupled to the infrared camera and the spotlight assembly further comprises a second power source coupled to the infrared spotlight.

4. The spotlight system of claim 1, wherein the infrared spotlight is configured to remain illuminated for a user defined duration.

5. The spotlight system of claim 1, wherein the infrared spotlight is configured to illuminate only after a predetermined amount of time has passed or been exceeded since a previous illumination.

6. The spotlight system of claim 1, further comprising a plurality of infrared spotlights each coupled to the infrared sensor of the spotlight assembly.

7. The spotlight system of claim 1, further comprising a sensor coupled to the infrared camera and the infrared flash, the infrared flash configured to illuminate in response to the sensor receiving a signal.

8. The spotlight system of claim 7, wherein the sensor coupled to the infrared camera is at least one of an infrared sensor, a seismic sensor, a passive infrared sensor, a magnetometer, or a radar.

9. The spotlight system of claim 7, wherein the signal is generated from at least one of an animal, a human, a vehicle, or other object.

10. An infrared spotlight system comprising:
an infrared camera coupled to an infrared flash;
a sensor capable of detecting a stimuli and generating a signal, the sensor being communicatively coupled to the infrared camera;
wherein the infrared flash is configured to illuminate upon receiving the signal generated by the sensor;
an infrared spotlight located remotely from the infrared camera;
an infrared sensor coupled to the infrared spotlight, the infrared sensor configured to detect the infrared flash; and
the infrared spotlight configured to illuminate when the infrared sensor detects the infrared flash from the infrared camera.

11. The infrared spotlight system of claim 10, further comprising a second infrared spotlight sensor coupled to the infrared spotlight wherein the second infrared spotlight sensor is configured to detect visible light.

12. The infrared spotlight system of claim 10, further comprising a power source coupled to the infrared spotlight.

13. The infrared spotlight system of claim 10, further comprising a plurality of infrared spotlights each coupled to the infrared sensor.

14. The infrared spotlight system of claim 10, wherein the infrared spotlight extends lighting beyond an area where the infrared flash of the infrared camera is capable of illuminating.

15. A method of using a spotlight system comprising:
detecting an object by a sensor;
illuminating an infrared flash of an infrared camera in response to detecting the object;
detecting the infrared flash via an infrared sensor; and
illuminating an infrared spotlight in response to detecting the infrared flash, wherein the infrared sensor and the infrared spotlight are located remotely from the infrared camera.

16. The method of claim 15, further comprising detecting an amount of visible light via a second sensor coupled to the infrared spotlight.

17. The method of claim 16, wherein the infrared spotlight is configured to transition to a reduced power mode in response to the detecting of the amount visible light by the second sensor.

18. The method of claim 15, further comprising powering the infrared camera via a first power source coupled to the infrared camera and powering the infrared spotlight via a second power source coupled to the infrared spotlight.

19. The method of claim 15, wherein the infrared spotlight illuminates for a user defined duration.

20. The method of claim 15, further comprising determining whether a predetermined amount of time has passed since a previous illumination, the infrared spotlight illuminating if the predetermined amount of time has passed or been exceeded.
